(19) United States
(12) Patent Application Publication
(10) Pub. No.: US 2007/0124733 A1
(43) Pub. Date: May 31, 2007

(54) Resource management in a multi-processor system

(75) Inventors: Reinder Jaap Bril, Waalre (NL); Dietwig Jos Clement Lowet, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/581,641

(22) PCT Filed: Jan. 5, 2005
(86) PCT No.: PCT/IB05/50038

§ 371 Date: Jun. 5, 2006

Related U.S. Application Data
(60) Provisional application No. 60/535,113, filed on Jan. 8, 2004.

(51) Int. Cl. G06F 9/46

(52) U.S. Cl. 718/104

(57) ABSTRACT

A method and apparatus is provided for use by a scheduler of a multi-processor data processing system to select task preemption points based on main memory requirements. There are three alternative preferred embodiments, depending on the allocation of tasks to processors: (1) Fixed Allocation: every task is allocated to a particular processor, i.e. each task exclusively executes on a given processor. This embodiment is preferred when processors are dedicated, i.e., where each processor differs essentially from every other processor; (2) Variable Allocation: every task may execute on every processor. At run-time the scheduler determines which processor executes which task. A task may be preempted while running on one processor, and later continue on another. This embodiment is preferred when all the processors are identical; and (3) Mixed Allocation: every task is allocated to a subset of processors. This is a natural approach when the set of processors can be divided into subsets in which the processors are identical.

The present invention relates to a resource management method and apparatus that is particularly, but not exclusively, suited to resource management of multi-processor real-time systems.

For systems-on-silicon (SoS) or systems-on-chip (SoC), memory is becoming a dominant limiting factor, since, from the point of view of the amount of silicon needed, adding another processing core is no longer a problem. As a consequence, a SoS or SoC may contain multiple processor cores.

The management of memory is a crucial aspect of resource management for a multiprocessor system. Various methods have been developed to optimize memory use for single processor systems, including generalizing the use of preemption points to the management of main memory, especially in real-time systems. In these approaches, rather than preempting tasks at arbitrary moments during their execution, those tasks are preferably only preempted at dedicated preemption points based on their memory usage.

In a typical prior art approach, suspension of a task is referred to as task preemption, or preemption of a task, and the term “task” is used to denote a unit of execution that can compete on its own for system resources such as memory, CPU, I/O devices, etc. For purposes of discussion, a task is assumed to be a succession of continually executing jobs, each of which comprises one or more sub-jobs. For example, a task can comprise “demultiplexing a video stream”, and involve reading-in incoming streams, processing the streams and outputting corresponding data. These steps are carried out with respect to each incoming data stream, so that reading, processing and outputting with respect to a single stream corresponds to performing one job, each having three sub-jobs. Thus, when there is a plurality of packets of data to be read-in and processed, the job would be performed a corresponding plurality of times. A sub-job can be considered to relate to a functional component of the job and in a multiprocessor system each stream would be assigned to a different processor or subset of processors.

A known method of scheduling a plurality of tasks in a data processing system requires that each sub-job of a task have a set of suspension criteria, called suspension data, that specifies the processing preemption points and corresponding conditions for suspension of a sub-job based on its memory usage [4] [5]. The amount of memory that is used by the data processing system is thus indirectly controlled by this suspension data, via these preemption points, which specify the amounts of memory required at these preemption points in a job's execution.

Thus, these preemption points can be utilized to avoid data processing system crashes due to a lack of memory. When a real-time task is characterized as comprising a plurality of sub-jobs, its preemption points preferably coincide with the sub-job boundaries of the task.

Data indicative of memory usage of a task conforming to the suspension data associated with each sub-job of a task can, for example, be embedded into a task via a line of code that requests a descheduling event, specifying that a preemption point has been reached in the processing of the task, i.e., a sub-job boundary has been reached. That is, the set of start points of the sub-jobs of a task constitute a set of preemption points of that task. The j^{th} preemption point Pᵢⱼ of a task τᵢ is characterized by information related to the preemption point itself and information related to the succeeding non-preemptible sub-job interval Iᵢⱼ between the j^{th} preemption point and the next preemption point, i.e., the (j+1)^{th} preemption point.

At run time, a task informs the controlling operating system when it arrives at preemption points, e.g. when it starts a sub-job, switches between sub-jobs, and completes a sub-job, and the operating system decides when and where execution of a task is preempted. Ideally, preemption may occur at a preemption point or at any other point during the execution of a task. However, such flexibility of choice of preemption comes at the cost of consistency so that preemption is limited to preemption points to maintain consistency.

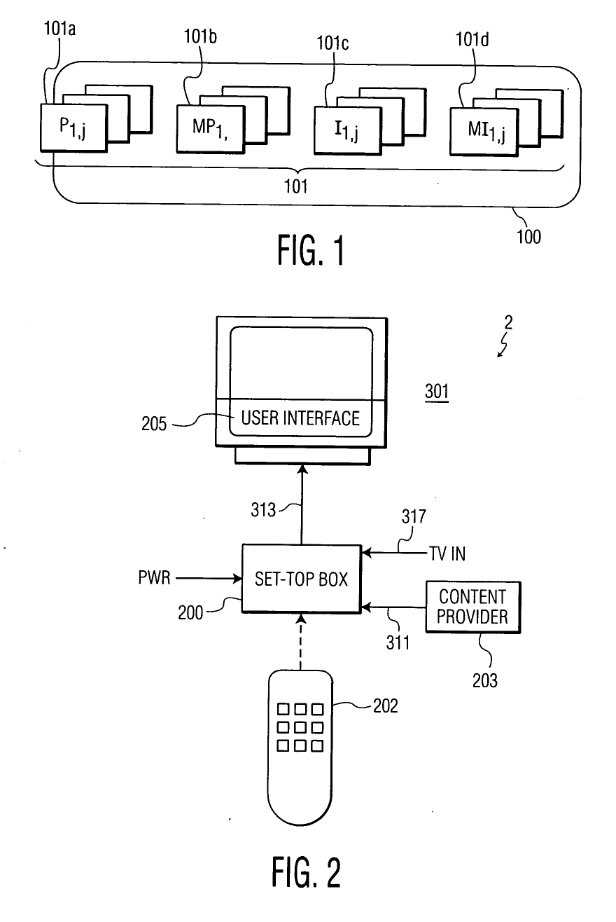

A prior art preemption point approach based on main memory requirements that does not jeopardize consistency of the system, necessarily limits the preemption of all tasks to their preemption points and matching synchronization primitives for controlling exclusive use of a resource to both be within a sub-job boundary. As is known in the art, a component (e.g. a software component, which can comprise one or more tasks) can have a programmable interface that comprises the properties, functions or methods and events that the component defines [6]. For purposes of discussion, a task is assumed to be accompanied by an interface 100 that includes, at a minimum, main memory data required by the task, MP_{i,j} 101b, as illustrated in FIG. 1.

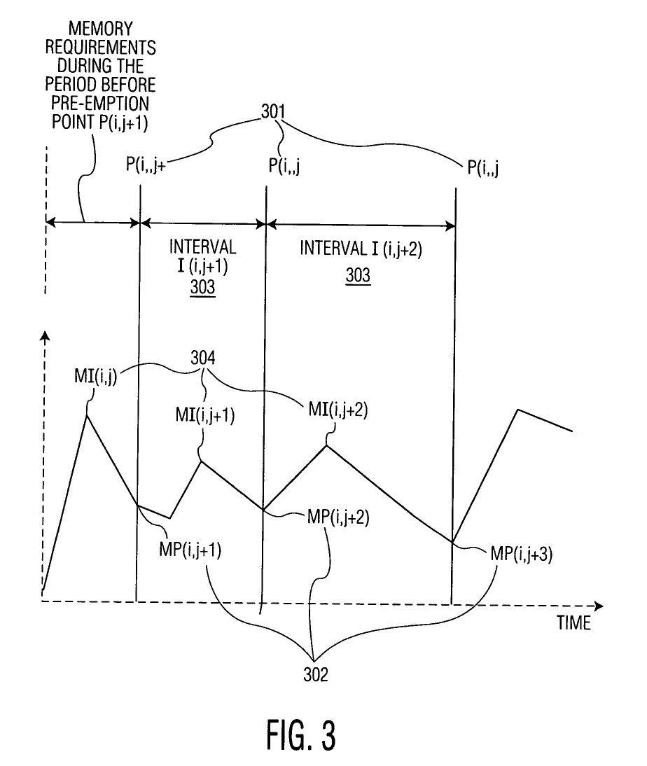

For the purposes of discussion, a task is assumed to be periodic and real-time, and characterized by a period T and a phasing F, where 0<=F<T, which means that a task comprises a sequence of sub-jobs, each of which is released at time F+nT, where n=0 . . . N. As an example only and as illustrated in FIG. 2, set-top box 200 is assumed to execute three tasks—(1) display menu on the User Interface 205, (2) retrieve text information from a content provider 203, and (3) process some video signals—and each these 3 tasks is assumed to comprise a plurality of sub-jobs. For ease of presentation, it is assumed that the sub-jobs are executed sequentially.

At least some of these sub-jobs can be preempted and the boundaries between these sub-jobs that can be preempted provide preemption points and are summarized in Table 1:

TABLE 1

| | | Number of preemptable |
|---|---|---|
| Task | | sub-jobs of task τᵢ |
| τᵢ | Task description | m(i) |
| τ₁ | display menu on the GUI | 3 |
| τ₂ | retrieve text information from content | 2 |
| | provider | |
| τ₃ | process video signals | 2 |

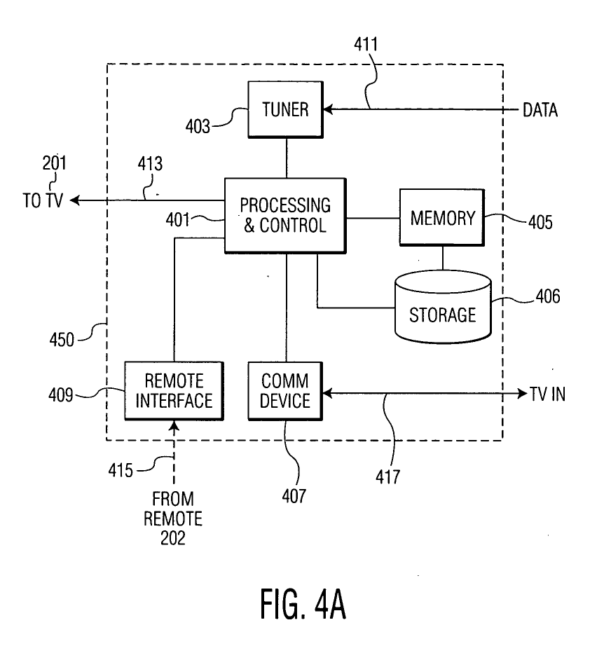

Referring also to FIG. 3, for each task the suspension data 101 comprises: information relating to a preemption-point P_{i,j} 301, such as the maximum amount of memory MP_{i,j} 302 required at the preemption point, and information relating to the interval I_{i,j} 303 between successive preemption-points, such as the worst-case amount of memory MI_{i,j} 304 required in an intra-preemption point interval (i represents task τᵢ and j represents a preemption point).

More specifically, suspension data 101 comprises data specifying
1. preemption point j of the task τᵢ (P_{i,j}) 101a;
2. maximum memory requirements of task τᵢ, MP_{i,j}, at preemption point j of that task, where 1≦j≦m(i) 101b;
3. interval, I_{i,j}, between successive preemption points j and (j+1) corresponding to sub-job j of task τᵢ, where 1≦j≦m(i) 101c; and
4. maximum (i.e. worst-case) memory requirements of task τᵢ, MI_{i,j}, in the interval j of that task, where 1≦j≦m(i) 101d.

Table 2 illustrates the suspension data 101 for the current example (each task has its own interface, so that in the current example, the suspension data 101 corresponding to the first task τ₁ comprises the data in the first row of Table 2, the suspension data 101 corresponding to the second task τ₂ comprises the second row of Table 2, etc.):

TABLE 2

| Task τᵢ | MP_{i,1} | MI_{i,1} | MP_{i,2} | MI_{i,2} | MP_{i,3} | MI_{i,3} |
|---|---|---|---|---|---|---|
| τ₁ | 0.2 | 0.6 | 0.2 | 0.4 | 0.1 | 0.6 |
| τ₂ | 0.1 | 0.5 | 0.2 | 0.8 | — | — |
| τ₃ | 0.1 | 0.2 | 0.1 | 0.3 | — | — |

Suppose a set-top box 200 is equipped with 1.5 Mbytes of memory. Under normal, or non-memory based preemption conditions, this set-top box 200 behaves as follows.

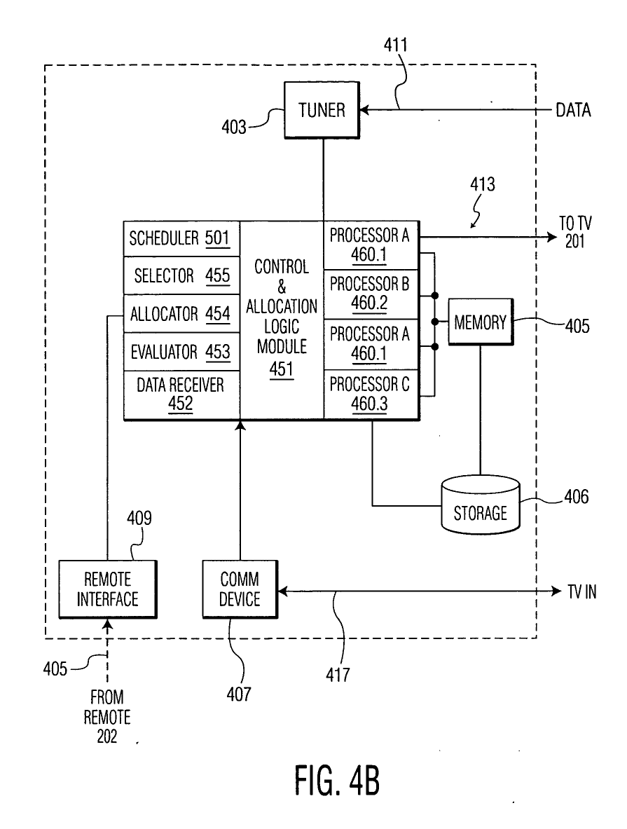

Referring now to FIG. 4A, a processor 401 may be expected to schedule tasks according to some sort of time slicing or priority based preemption, meaning that all 3 tasks run concurrently, i.e. effectively at the same time. It is therefore possible that each task can be scheduled to run its most memory intensive sub-job at the same time. The worst-case memory requirement of these three tasks, M^{P}, is given by:

$${M}^{P} = {\sum }_{i = 1}^{3} {max}_{j = 1}^{m ( i )} {MI}_{i , j} \qquad ( Equation 1 )$$

For tasks τ₁, τ₂ and τ₃ M^{P} is thus the maximum memory requirements of τ₁ (being MI_{1,1}) plus the maximal memory requirements of task τ₂ (being MI_{2,2}) plus the maximal memory requirements of task τ₃ (being MI_{3,2}). These maximum requirements are indicated by the Table 2 entries in bold:
M^{P}=0.6+0.8+0.3=1.7 Mbytes.

This exceeds the memory available to the set-top box 200 by 0.2 Mbytes, so that, in the absence of any precautionary measures and if these sub-jobs are to be processed at the same time, the set-top box 200 crashes.

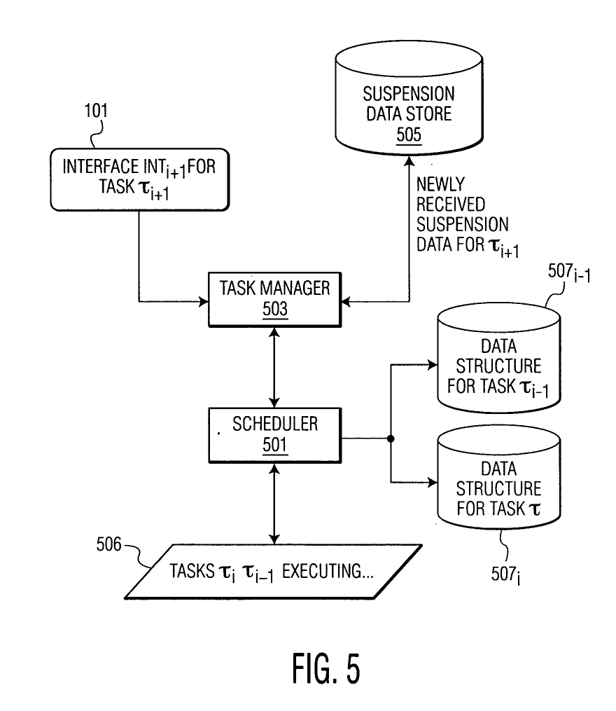

Referring now to FIG. 5, suppose tasks are scheduled in accordance with a scheduling algorithm and a data structure is maintained for each task τᵢ after it has been created and that matching pairs of primitives for exclusive use of a resource do not span a sub-job boundary. Suppose further that a scheduler 501 employs a conventional priority-based, preemptive scheduling algorithm, which essentially ensures that, at any point in time, the currently running task is the one with the highest priority among all ready-to-run tasks in the system. As is known in the art, the scheduling behavior can be modified by selectively enabling and disabling preemption for the running, or ready-to-run, tasks.

A task manager 503 receives the suspension data 101 corresponding to a newly received task and evaluates whether preemption is required or not and if it is required, passes this newly received information to the scheduler 501, requesting preemption. Suppose details of the tasks are as defined in Table 2, and assume that task τ₁ (and only τ₁) is currently being processed and that the scheduler is initially operating in a mode in which there are no memory-based constraints.

Suppose now that task τ₂ is received by the task manager 503, which reads the suspension data 101 from its interface Int₂ 100, and identifies whether or not the scheduler 501 is working in accordance with memory-based preemption. Since, in this example, it is not, the task manager 503 evaluates whether the scheduler 501 needs to change to memory-based preemption. This therefore involves the task manager 503 retrieving worst case suspension data corresponding to all currently executing tasks (in this example task τ₁) from a suspension data store 505, evaluating Equation 1 and comparing the evaluated worst-case memory requirements with the memory resources available. Continuing with the example introduced in Table 2, Equation 1, for τ₁ and τ₂, is:

$${M}^{P} = {\sum }_{i = 1}^{2} {max}_{j = 1}^{m ( i )} {MI}_{i , j} = 0.6 + 0.8 = 1.4 Mbytes$$

This is less than the available memory, so there is no need to change the mode of operation of the scheduler 501 to memory-based preemption (i.e. there is no need to constrain the scheduler based on memory usage). Thus, if the scheduler 501 were to switch between task τ₁ and task τ₂—e.g. to satisfy execution time constraints of task τ₂, meaning that both tasks effectively reside in memory at the same time—the processor never accesses more memory than is available.

Next, and before tasks τ₁ and τ₂ have completed, another task τ₃ is received. The task manager 503 reads the suspension data 101 from interface Int₃ associated with the task τ₃, evaluating whether the scheduler 501 needs to change to memory-based preemption. Assuming that the scheduler 501 is multi-tasking tasks τ₁ and τ₂, the worst case memory requirements for all three tasks is now

$${M}^{P} = {\sum }_{i = 1}^{3} {max}_{j = 1}^{m ( i )} {MI}_{i , j} = 0.6 + 0.8 + 0.3 = 1.7 Mbytes$$

This exceeds the available memory, so the task manager 503 requests and retrieves memory usage data MP_{i,j},MI_{i,j} 101b, 101d for all three tasks from the suspension data store 505, and evaluates whether, based on this retrieved memory usage data, there are sufficient memory resources to execute all three tasks. This can be ascertained through evaluation of the following equation:

$$\begin{matrix}{M}^{D} = {\sum }_{i = 1}^{3} {max}_{j = 1}^{m ( i )} {MP}_{i , j} + {max}_{i = 1}^{3} ( {max}_{j = 1}^{m ( i )} {MI}_{i , j} - {max}_{j = 1}^{m ( i )} {MP}_{i , j} ) \\ = 0.2 + 0.2 + 0.1 + max ( 0.6 - 0.2 , 0.8 - 0.2 , 0.3 - 0.1 ) \\ = 0.5 + 0.6 \\ = 1.1 Mbytes .\end{matrix} \qquad ( Equation 2 )$$

This memory requirement is lower than the available memory, meaning that, provided the tasks are preempted based on their memory usage, all three tasks can be executed concurrently.

Accordingly, the task manager 503 invokes “memory-based preemption mode” by instructing the tasks to transmit deschedule instructions to the scheduler 501 at their designated preemption points MP_{i,j}. In this mode, the scheduler 501 allows each task to run non-preemptively from one preemption point to the next, with the constraint that, at any point in time, at most one task at a time can be at a point other than one of its preemption points. Assuming that the newly arrived task starts at a preemption point, the scheduler 501 ensures that this condition holds for the currently running tasks, thereby constraining all but one task to be at a preemption point.

Thus, in one known memory-based preemption mode, the scheduler 501 is only allowed to preempt tasks at their memory preemption points (i.e. in response to a deschedule request from the task at their memory-based preemption points).

When one of the tasks has terminated, the terminating task informs the task manager 503 that it is terminating, causing the task manager 503 to evaluate Equation 1 and if the worst case memory usage (taking into account removal of this task) is lower than that available to the scheduler 501, the task manager 503 can cancel memory-based preemption, which has the benefit of enabling the system to react faster to external events (since the processor is no longer “blocked” for the duration of the sub-jobs). In general, termination of a task is typically caused by its environment, e.g. a switch of channel by the user or a change in the data stream of the encoding applied (requiring another kind of decoding), meaning that the task manager 503 and/or scheduler 501 should be aware of the termination of a task and probably even instruct the task to terminate.

It should be noted that, when invoked, memory-based preemption constraints are obligatory.

The tasks have been described as software tasks, but a task can also be implemented in hardware. Typically, a hardware device (behaving as a hardware task) is controlled by a software task, which allocates the (worst-case) memory required by the hardware device, and subsequently instructs the hardware task to run. When the hardware task completes, it informs the software task, which subsequently de-allocates the memory. Hence, by having a controlling software task, hardware tasks can simply be dealt with as described above.

This approach applies to a single processor system and is not optimized for a multi-processor system and thus a multi-processor optimization is needed.

The present invention provides optimizations of the single processor approach to memory based resource management described above, for multi-processor systems. Consider a set Γ of n tasks τᵢ (1≦i≦n) and a set P of p processors πₖ (1≦k≦p), where n is typically much larger than p and assume a fixed-priority preemptive scheduling (FPPS) scheme for the non-constrained mode, and a fixed-priority scheduling scheme with deferred preemption (FPDP) scheme for the memory-based preemption mode.

There are three alternative preferred embodiments, depending on the allocation of tasks to processors:
1. Fixed Allocation: every task τᵢ is allocated to a particular processor πₖ, i.e. task τᵢ will exclusively execute on processor πₖ. This embodiment is preferred when processors are dedicated, i.e., where each processor differs essentially from every other processor.
2. Variable Allocation: every task τᵢ may execute on every processor πₖ. At run-time the scheduler determines which processor executes which task. A task may be preempted while running on one processor, and later continue on another. This embodiment is preferred when all the processors are identical.
3. Mixed Allocation: every task τᵢ is allocated to a subset of processors. This is a natural approach when the set of processors can be divided into subsets in which the processors are identical.

The foregoing and other features and advantages of the invention will be apparent from the following, more detailed description of preferred embodiments as illustrated in the accompanying drawings in which reference characters refer to the same parts throughout the various views.

FIG. 1 illustrates a schematic diagram of components of a task interface according to an embodiment of the present invention;

FIG. 2 illustrates a schematic diagram of an example of a digital television system in which an embodiment of the present invention is operative;

FIG. 3 illustrates a schematic diagram of the relationships between components of the task interface illustrated in FIG. 1 for a single processor.

FIG. 4A illustrates components constituting the set-top; box of FIG. 2, for a single processor system.

FIG. 4B illustrates components constituting the set-top box of FIG. 2 for a multiprocessor system.

FIG. 5 illustrates components of the processor of the set-top box illustrated in FIG. 2 and FIG. 4A.

It is to be understood by persons of ordinary skill in the art that the following descriptions are provided for purposes of illustration and not for limitation. An artisan understands that there are many variations that lie within the spirit of the invention and the scope of the appended claims. Unnecessary detail of known functions and operations may be omitted from the current description so as not to obscure the present invention.

High volume electronic (HVE) consumer systems, such as digital TV sets, digitally improved analog TV sets and set-top boxes (STBs) must provide real-time services while remaining cost-effective and robust. Consumer products, by their nature, are heavily resource constrained. As a consequence, the available resources have to be used very efficiently, while preserving typical qualities of HVE consumer systems, such as robustness, and meeting stringent timing requirements. Concerning robustness, no one expects, for example, a TV set to fail with the message “please reboot the system”.

Significant parts of the media processing in HVE consumer systems are implemented in on-board software that handles multiple concurrent streams of data, and in particular must very efficiently manage system resources, such as main memory, in a multi-tasking environment. Consider a set-top box as an example of an HVE consumer system requiring real-time resource management. Conventionally, as illustrated in FIG. 2, a set-top box 200 receives input for television 201 from a content provider 203 (a server or cable) and from a user interface 205. The user interface 205 comprises a remote control interface for receiving signals from a user-controlled remote device 202, e.g., a handheld infrared remote transmitter. The set-top box 200 receives at least one data stream from at least one of an antenna and a cable television outlet, and performs at least one of processing the data stream or forwarding the data stream to television 201. A user views the at least one data stream displayed on television 201 and via user interface 205, makes selections based on what is being displayed. The set-top box 200 processes the user selection input and based on this input may transmit to the content provider 203 the user input, along with other information identifying the set-top 200 and its capabilities.

FIG. 4B illustrates a simplified block diagram of an exemplary system 450 of a typical set-top box 200 that may include a plurality of processors 460.1-460.3 managed by a control and allocation logic module which allocates tasks to processors 460.1-460.3 and controls the overall operation of set-top box 200. The control and allocation logic module 451 comprises a data receiver 452 for receiving put data from the network 407 and from storage 406, an evaluator 453 for evaluating memory usage, an allocator 454 for allocating tasks to processors, a selector 455 for selecting tasks to initiate and terminate execution thereof and a scheduler 501 for scheduling tasks for execution and descheduling executing tasks. The control and allocation logic module 451 is coupled to a television tuner 403, a memory 405, a long term storage device 406, a communication interface 407, and a remote interface 409. The television tuner 403 receives television signals over transmission line 411 and these signals may originate from at least one of an antenna (not shown) and a cable television outlet (not shown). The control & allocation logic module 451 manages the user interface 205, providing data, audio and video output to the television 201 via line 413. The remote interface 409 receives signals from the remote control via the wireless connection 415. The communication interface 407 interfaces between the set-top box 200 and at least one remote processing system, such a Web server, via data path 417. The communication interface 417 is at least one of a telephone modem, an Integrate Services Digital Network (ISDN) adapter, a Digital Subscriber Line (xDSL), a cable television modem, and any other suitable data communication device. The exemplary system 450 of FIG. 4B is for descriptive purposes only. Although the description may refer to terms commonly used in describing particular set-top boxes 200, the description and concepts equally apply to other control processors, including systems having architectures dissimilar to that shown in FIG. 4B.

The control and allocation logic module 451, in a preferred embodiment, is configured to allocate a plurality of real-time tasks relating to the control of the set-top box 200 to a plurality of multi-processors 460.1-460.3 that share a memory 405. These real-time tasks include changing channels, selection of a menu option displayed on the user interface 205, decoding incoming data streams, recording incoming data streams using the long term storage device 406 and replaying them, etc. The operation of the set-top box is determined by these real-time control tasks based on characteristics of the set-top box 100, incoming video signals via line 411, user inputs via user interface 205, and any other ancillary input.

In a preferred embodiment, multi-processors share memory 405. These multi-processors 460.1-460.3 may each be CPUs, or co-processors, or other processing devices. In a preferred embodiment, the same task is never executed simultaneously by two (or more) processors. In a preferred embodiment, the control and allocation logic module comprises a single task-manager for the entire set of processors 460.1-460.3. This is. a centralized approach for discussion purposes only. The present invention is not constrained to cenitralized approaches, and decentralized versions may be easily conceived by individuals experienced in the art.

Whenever every task τ is allocated to a particular processor π, the set Γ of tasks may be partitioned into p disjoint sets Γ₁-Γₚ, where the subset Γₖ is allocated to processor πₖ. The maximum amount of memory required by the subset of tasks Γₖ under FPPS as executed by processor πₖ is given by (Eq. 1s′), which is a variant of (Eq. 1). The term nₖ in (Eq. 1s′) denotes the number (i.e. the cardinality of the subset Γₖ) of tasks allocated to processor πₖ, and the variable i is assumed to range over the tasks of Γₖ.

$${M}_{k}^{P} = {\sum }_{i = 1}^{{n}_{k}} {max}_{j = 1}^{m ( i )} {MI}_{i , j} \qquad ( Eq . 1 {s}^{′} )$$

The total memory requirements M^{P} of the entire set Γ of tasks is determined by adding the results found for each subset of tasks; see (Eq. 1m^{fix}).

$${M}^{P} = {\sum }_{k = 1}^{p} {M}_{k}^{P} \qquad ( Eq . 1 {m}^{fix} )$$

When M^{P} does not exceed the available memory M_{sys}, there is no need to constrain the scheduling of the tasks on any of the processors. When M^{P} does exceed M_{sys}, we may constrain the scheduling of one or more tasks on one or more processors. The effect of constraining the scheduling of all tasks on a single processor can be determined using Eq. 2s′), which is a variant of (Eq. 2s).

$${M}_{k}^{D} = {\sum }_{i = 1}^{{n}_{k}} {max}_{j = 1}^{m ( i )} {MP}_{i , j} + {max}_{1 \leq i \leq nk} ( {max}_{j = 1}^{m ( i )} {MI}_{i , j} - {max}_{j = 1}^{m ( i )} {MP}_{i , j} ) \qquad ( Eq . 2 {s}^{′} )$$

The effect of constraining the scheduling of all tasks on all processors can be determined by (Eq. 2m^{fix}), where the total memory requirements M^{D} is the sum of the memory requirements Mₖ^{D} of each set Γₖ.

$${M}^{D} = {\sum }_{k = 1}^{p} {M}_{k}^{D} \qquad ( Eq . 2 {m}^{fix} )$$

Clearly, there are many intermediate alternative embodiments, such as constraining all the tasks on just a subset of the processors, and constraining only a subset of tasks on a subset of the processors.

Alternatively, every task may be executed on every processor 460.1-460.3, and scheduling of the tasks is performed by the control and allocation logic module 451. The maximum memory requirements M^{P} for the non-constrained mode remains the same, i.e. can be determined using (Eq. 1s)

$${M}^{P} = {\sum }_{i = 1}^{n} {max}_{j = 1}^{m ( i )} {MI}_{i , j} \qquad ( Eq . 1 s )$$

The constrained mode (i.e. all tasks are only preempted at their preemption points) requires a variant of (Eq. 2s)

$$\begin{matrix}{M}^{D} = {\sum }_{i = 1}^{n} {max}_{j = 1}^{m ( i )} {MP}_{i , j} + {max}_{i = 1}^{3} ( {max}_{j = 1}^{m ( i )} {MI}_{i , j} - {max}_{j = 1}^{m ( i )} {MP}_{i , j} ) \\ = 0.2 + 0.2 + 0.1 + max ( 0.6 - 0.2 , 0.8 - 0.2 , 0.3 - 0.1 ) \\ = 0.5 + 0.6 \\ = 1.1 Mbytes .\end{matrix} \qquad ( Eq . 2 s )$$

because p tasks may now run in parallel on p processors. The total memory requirements M^{D} is now given by (Eq. 2m^{var}).

$${M}^{D} = {\sum }_{i = 1}^{n} {max}_{j = 1}^{m ( i )} {MP}_{i , j} + {max}_{1 \leq {i}_{1} < {i}_{2} {<}_{⋯} < {i}_{p} \leq n} {\sum }_{k = 1}^{p} ( {max}_{j = 1}^{m ( {i}_{k} )} {MI}_{{i}_{k} , j} - {max}_{j = 1}^{m ( {i}_{k} )} {MP}_{{i}_{k} , j} ) \qquad ( Eq . 2 {m}^{var} )$$

Note that (Eq. 2m^{var}) assumes n≧p, and that (Eq. 2m^{var}) is also only valid for n≧p. For the special case n<p, the equation can be simplified to

$${M}^{D} = {\sum }_{i = 1}^{n} {max}_{j = 1}^{m ( i )} {MI}_{i , j}$$

Clearly, there are many intermediate embodiments, such as constraining only a subset of tasks.

As an example, consider the case of two processors (i.e. p=2), and three tasks (i.e. n=3). It is assumed that the tasks have the same characteristics (i.e. memory requirements) as described in Tables 1 and 2 above, and their accompanying discussion. The maximum memory requirements M^{P} for the non-constrained mode remains the same, i.e. can be determined using (Eq. 1), and hence exceeds the available memory M_{sys}. Using (Eq. 2m^{var}) the maximum memory requirements M^{D} for memory-based preemption is:

$$\begin{matrix}{M}^{D} = {\sum }_{i = 1}^{3} {max}_{j = 1}^{m ( i )} {MP}_{i , j} + {max}_{1 \leq {i}_{1} < {i}_{2} \leq 3} {\sum }_{k = 1}^{2} ( {max}_{j = 1}^{m ( {i}_{k} )} {MI}_{{i}_{k} , j} - \\ {max}_{j = 1}^{m ( {i}_{k} )} {MP}_{{i}_{k} , j} ) \\ = 0.2 + 0.2 + 0.1 + max ( 0.4 + 0.6 , 0.4 + 0.2 , 0.6 + 0.2 ) \\ = 0.5 + 1.0 \\ = 1.5 Mbytes\end{matrix}$$

The memory requirement is lower than the available memory, meaning that provided that the tasks are preempted only at their preemption points, all three tasks can be executed concurrently.

Assume there are s pair-wise disjoint subsets P₁, . . . , Pₛ of processors. Let every task be allocated to a particular subset P₁ of processors, where 1≦1≦s. The set of tasks may therefore be divided in s pair-wise disjoint subsets Γ₁, . . . , Γₛ of tasks. For ease of presentation, the tasks in subset Γ₁ are denoted by τᵢ, where 1≦i≦n₁, i.e. the tasks per subset of tasks are numbered. Similar to the variable allocation described above, the maximum memory requirements M₁^{P} for subset P₁ for the non-constrained mode can be determined using (Eq. 1s″).

The maximum amount of memory required by the subset of tasks Γ₁ in the non-constrained mode executed by the subset P₁ of processor πₖ is given by (Eq. 1s″), which is a variant of (Eq. 1).

$${M}_{1}^{P} = {\sum }_{i = 1}^{{n}_{1}} {max}_{j = 1}^{m ( i )} {MI}_{i , j} \qquad ( Eq . 1 {s}^{′′} )$$

Note that (Eq. 1s″) is similar, but not identical, to (Eq. 1s′). Whereas 1 ranges over subsets of processors in the former equation, k ranges over the processors in a subset in the latter equation. The total memory requirements M^{P} for all s subsets of processors can be found by taking the sum of the requirements for the individual subsets:

$${M}^{P} = {\sum }_{l = 1}^{s} {M}_{l}^{P} \qquad ( Eq . 1 {m}^{mix} )$$

When M^{P} exceeds M_{sys}, the scheduling is constrained of one or more tasks of one or more subsets of tasks executed on their associated subsets of processors. The effect of constraining the scheduling of all n₁ tasks of Γ₁ on a single subset P₁ of p₁ processors can be determined using (Eq. 2m^{mix}), which is similar to (Eq. 2m^{var}):

$${M}_{1}^{D} = {\sum }_{i = 1}^{{n}_{1}} {max}_{j = 1}^{m ( l )} {MP}_{i , j} + {max}_{1 \leq {i}_{1} < {i}_{2} {<}_{⋯} < {i}_{p} \leq {n}_{1}} {\sum }_{k = 1}^{{p}_{1}} ( {max}_{j = 1}^{m ( {i}_{k} )} {MI}_{{i}_{k} , j} - {max}_{j = 1}^{m ( {i}_{k} )} {MP}_{{i}_{k} , j} ) \qquad ( Eq . 2 {m}^{mix} )$$

Similarly to (Eq. 2m^{var}), (Eq. 2m^{mix}) only holds for n₁≧p₁.

The effect of constraining the scheduling of all tasks of every subset of tasks on every subset of processors can be determined by (Eq. 2m^{mix′}), where the total memory requirements M^{D} is the sum of the memory requirements M₁^{D} of each subset of processor P₁.

$${M}^{D} = {\sum }_{i = 1}^{s} {M}_{1}^{D} \qquad ( Eq . 2 {m}^{ {mix}^{′}} )$$

As for the fixed allocation and variable allocation cases described above, for mixed allocation there are many intermediate solutions between the non-constrained mode and the memory-based preemption mode in which all tasks are only preempted at their preemption points.

While the preferred embodiments of the present invention have been illustrated and described, it will be understood by those skilled in the art that various changes and modifications may be made, and equivalents may be substituted for elements thereof without departing from the true scope of the present invention. In addition, many modifications may be made to adapt the teaching of the present invention to a particular situation without departing from its central scope. Therefore it is intended that the present invention not be limited to the particular embodiments disclosed as the best mode contemplated for carrying out the present invention, but that the present invention include all embodiments falling within the scope of the appended claims.

1. A method of scheduling a plurality of tasks in a data processing system having a plurality of processors, comprising the steps of:
for each task of the plurality, providing suspension data specifying suspension of the task based on memory used thereby;
allocating each of said plurality of tasks to a processor of said plurality of processors; and
each processor performing the steps of:
(i) processing one the tasks allocated to the processor,
(ii) monitoring for an input indicative of memory used by the task matching the suspension data associated with the task,
(iii) suspending said task on the basis of said monitored input, and
(iv) processing a different one of the tasks allocated to the processor.

2. The method of claim 1, wherein:
allocation of a task to a processor is based on one of
a. fixed allocation having every task allocated to a particular processor;
b. variable allocation having every task allocated to every processor; and
c. mixed allocation having every task allocated to a subset of said plurality of processors.

3. The method of claim 2, wherein said input comprises data indicative of a suspension request.

4. The method of claim 3, further comprising the steps of:
receiving first data identifying maximum memory usage associated with the plurality of tasks;
receiving second data identifying memory available for processing the plurality of tasks;
identifying, on the basis of the first and second data, whether there is sufficient memory available to process the tasks; and
wherein, said monitoring and suspending steps are performed only in response to identifying insufficient memory.

5. The method of claim 4, further comprising the steps of:
monitoring termination of tasks; and
in response to a task termination, repeating said step of identifying availability of memory in response to a task terminating.

6. The method of claim 5, in which, in response to identifying sufficient memory to execute the remaining tasks, the monitoring step is deemed unnecessary.

7. The method of claim 6, further comprising the steps of:
receiving first data identifying maximum memory usage associated with the plurality of tasks;
receiving second data identifying memory available for processing the plurality of tasks;
identifying, on the basis of the first and second data, whether there is sufficient memory available to process the tasks; and
wherein, said monitoring and suspending steps are performed only in response to identifying insufficient memory.

8. The method of claim 7, further comprising the steps of:
monitoring termination of tasks; and
in response to a task termination, repeating said step of identifying availability of memory in response to a task terminating.

9. The method of claim 8, in which, in response to identifying sufficient memory to execute the remaining tasks, the monitoring step is deemed unnecessary.

10. The method of claim 2, further comprising the steps of:
receiving first data identifying maximum memory usage associated with the plurality of tasks;
receiving second data identifying memory available for processing the plurality of tasks;
identifying, on the basis of the first and second data, whether there is sufficient memory available to process the tasks; and
wherein, said monitoring and suspending steps are performed only in response to identifying insufficient memory.

11. The method claim 10, further comprising the steps of:
monitoring termination of tasks; and
in response to a task termination, repeating said step of identifying availability of memory in response to a task terminating.

12. The method according to claim 11, in which, in response to identifying sufficient memory to execute the remaining tasks, the monitoring step is deemed unnecessary.

13. A method of scheduling a plurality of tasks in a data processing system having a plurality of processors, comprising the steps of:
for each task of the plurality, providing suspension data specifying suspension of the task based on memory used thereby;
allocating each of said plurality of tasks to a processor of said plurality of processors based on one of
fixed allocation having every task allocated to a particular processor,
variable allocation having every task allocated to every processor, and
mixed allocation having every task allocated to a subset of said plurality of processors; and
each processor performing the steps of:
(i) processing one the tasks allocated to the processor,
(ii) monitoring for an input indicative of memory used by the task matching the suspension data associated with the task,
(iii) suspending said task on the basis of said monitored input, and
(iv) processing a different one of the tasks allocated to the processor.

14. A scheduler for use in a data processing system having a plurality of processors, the data processing system being arranged to execute a plurality of tasks on said plurality of processors and having access to a specified amount of memory for use in executing the tasks, the scheduler comprising:
a data receiver arranged to receive data identifying maximum memory usage associated with a task;
an evaluator arranged to identify, on the basis of the received data, whether there is sufficient memory to execute the tasks;
an allocator arranged to allocate each of said plurality of tasks to a processor of said plurality of processors based on one of
a. fixed allocation having every task allocated to a particular processor,
b. variable allocation having every task allocated to every processor, and
c. mixed allocation having every task allocated to a subset of said plurality of processors;
a selector arranged to select at least one task for suspension during execution of the task, said suspension coinciding with a specified memory usage by the task; and
a scheduler 501 arranged to initiate execution of said allocated task and suspend said selected task,
wherein, in response to the evaluator identifying that there is insufficient memory to execute the plurality of tasks, the selector selects at least one task for suspension, on the basis of its specified memory usage, and the specified amount of memory available to the data processing system, and the scheduler suspends execution of the at least one selected task in response to the task using-the specified memory.

15. A scheduler according to claim 14, wherein the evaluator is arranged to monitor termination of tasks, and in response to a task terminating, to identify whether there is sufficient memory to execute the remaining tasks.

16. A scheduler according to claim 15, wherein, in response to the evaluator identifying sufficient memory to execute the remaining tasks, the selector is arranged to deselect said selected at least one task.

17. A data processing system having a plurality of processors arranged to execute a plurality of tasks, the data processing system including:
memory arranged to hold instructions and data during execution of a task;
receiving means arranged to receive data identifying maximum memory usage associated with a task and data specifying preemptability of the task;
evaluating means arranged to identify, on the basis of the received data, whether there is sufficient memory to execute the tasks;
an allocator arranged to allocate each of said plurality of tasks to a processor of said plurality of processors based on one of
fixed allocation having every task allocated to a particular processor,
variable allocation having every task allocated to every processor, and
mixed allocation having every task allocated to a subset of said plurality of processors; and
a scheduler arranged to schedule execution of the tasks on the basis of input received from the evaluating means,
wherein, in response to identification of insufficient memory to execute the plurality of tasks, the scheduler is arranged to suspend execution of at least one task in dependence on memory usage by the task.

18. A method of transmitting data to a data processing system having a plurality of processors, the method comprising:
allocating each task of a plurality of tasks to a processor of said plurality of processors based on one of
fixed allocation having every task allocated to a particular processor,
variable allocation having every task allocated to every processor, and
mixed allocation having every task allocated to a subset of said plurality of processors;
transmitting data for use by the data processing system in processing each task of said plurality of tasks;
transmitting suspension data specifying suspension of each task of said plurality of tasks based on memory usage during processing thereof;
wherein, the data processing system is configured to perform a process comprising:
monitoring for an input indicative of memory usage of each task matching the suspension data associated with the task; and
suspending processing of said each task on the basis of said monitored input.

19. A method according to claim 18, wherein the suspension data includes data identifying maximum memory usage associated with said each task.

20. A method according to claim 18, wherein the suspension data identifies at least one point at which processing of each task can be suspended, based on memory usage of said each task. .

21. A method according to claim 20, wherein said each task comprises a plurality of sub-jobs and said data identifying at least one point at which processing of said each task can be suspended corresponds to each such sub-job.

22. A method according to claim 20, wherein the suspension data includes data identifying maximum memory usage associated with said each task.

23. A method according to claim 22, wherein said each task comprises a plurality of sub-jobs and said data identifying at least one point at which processing of said each task can be suspended corresponds to each such sub-job.

24. A method of configuring a plurality of tasks for use in a data processing system having a plurality of processors, the method including associating suspension data with the task, the suspension data specifying suspension of the task based on memory usage associated therewith, wherein the data processing system is arranged to perform a process in respect of a plurality of tasks executing on a plurality of processors, the process comprising:
allocating each task of said plurality of tasks to a processor of said plurality of processors based on one of
fixed allocation having every task allocated to a particular processor,
variable allocation having every task allocated to every processor, and
mixed allocation having every task allocated to a subset of said plurality of processors;
monitoring for an input indicative of memory usage of the task matching the suspension data associated with the task; and
suspending processing of said task on the basis of said monitored input.

25. A computer program, comprising a set of instructions arranged to cause a processing system to perform the method according to of claim 1.

26. A computer program, comprising a set of instructions arranged to cause a processing system to perform the method according to of claim 2.
